(19) United States
(12) Patent Application Publication
(10) Pub. No.: US 2006/0200861 A1
(43) Pub. Date: Sep. 7, 2006

(54) Robust and fault-tolerant registry for web-enabled information handling devices to protect against "malware"

(75) Inventors: Devendra B. Godbole, Round Rock, TX (US); Douglas M. Anson, Dripping Springs, TX (US); Paul E. Ferguson JR., Austin, TX (US); Steven R. Spademan, Austin, TX (US)

Correspondence Address: BAKER BOTTS, LLP, 910 LOUISIANA, HOUSTON, TX, 77002-4995, US

(73) Assignee: DELL PRODUCTS L.P., Round Rock, TX (US)

(21) Appl. No.: 11/071,976

(22) Filed: Mar. 4, 2005

(51) Int. Cl. G06F 12/14

(52) U.S. Cl. 726/22

(57) ABSTRACT

A method and system for modifying a computer's registry so that it is easily cleansed of spyware and other web-installed software. The registry is structured like an ACID type database, and is partitioned so that metadata associated with web-installed software are stored in a special partitioned. The registry also has revision control, so that prior versions can be retrieved and used if the current registry is corrupted.

### TECHNICAL FIELD

This invention relates to web-enabled information handling devices, and more particularly to protecting such devices from “spyware” (malware) attacks.

### BACKGROUND

As the value and use of information continues to increase, individuals and businesses seek additional ways to process and store information. One option available to users is information handling systems. An information handling system generally processes, compiles, stores, and/or communicates information or data for business, personal, or other purposes thereby allowing users to take advantage of the value of the information. Because technology and information handling needs and requirements vary between different users or applications, information handling systems may also vary regarding what information is handled, how the information is handled, how much information is processed, stored, or communicated, and how quickly and efficiently the information may be processed, stored, or communicated. The variations in information handling systems allow for information handling systems to be general or configured for a specific user or specific use such as financial transaction processing, airline reservations, enterprise data storage, or global communications. In addition, information handling systems may include a variety of hardware and software components that may be configured to process, store, and communicate information and may include one or more computer systems, data storage systems, and networking systems.

These days, most personal computers are connected to the Internet. When users browse web sites, it is easy to download software, with or without the user's knowledge. Such software can have various undesired side-effects, such as poor computer performance, pop-ups, browser hijacking.

One category of unwanted software is known as “spyware”, defined as software that covertly gathers user information through the user's Internet connection without his or her knowledge, usually for advertising purposes. Once installed, the spyware monitors user activity on the Internet and transmits that information in the background to someone else. Spyware can also gather information about e-mail addresses and even passwords and credit card numbers.

A catchall name for unwanted software is “malware”. In additional to the various problems set out above, an especially troublesome aspect of malware is that once it is installed, it is difficult to uninstall.

### SUMMARY

In accordance with teachings of the present disclosure, a system and method are described for protecting a web-enabled information handling system against malware.

In one embodiment of the invention, the registry of the information handling system is operated as a database having ACID (atomicity, consistency, isolation, and durability) properties. The registry is partitioned into at least two partitions. A main partition stores entries associated with software installed locally, such as via a hard disk drive. A secondary partition stores entries associated with software installed via the Internet. The registry may also be managed with revision control, such that prior registry versions are stored and may be re-instated if a current version is corrupted.

As a result of these modifications, the registry is more robust and resilient than today's registries. The modifications can be made to any “metadata” type registry, and notably, they may be easily implemented with a registry associated with a Windows operating system.

Registries that are modified in accordance with the invention will avoid user problems and dissatisfaction associated with malware. Because malware is a significant driver of customer support calls, the invention can substantially reduce the customer support burden for computer manufacturers.

### BRIEF DESCRIPTION OF THE DRAWINGS

A more complete understanding of the present embodiments and advantages thereof may be acquired by referring to the following description taken in conjunction with the accompanying drawings, in which like reference numbers indicate like features, and wherein:

FIG. 1 illustrates an information handling system having a registry structured and operated in accordance with the invention.

### DETAILED DESCRIPTION

The following description is directed to providing a solution to problems associated with removing spyware and other types of malware. In general, modifications are made to the registry so that it is more robust, and more like a database than its current repository structure.

As explained below, a special partition within the registry of the operating system is created. Programs that are automatically installed via a web browser are stored in that partition. This registry is easy to clean, and the core registry is not affected by the web-installed programs.

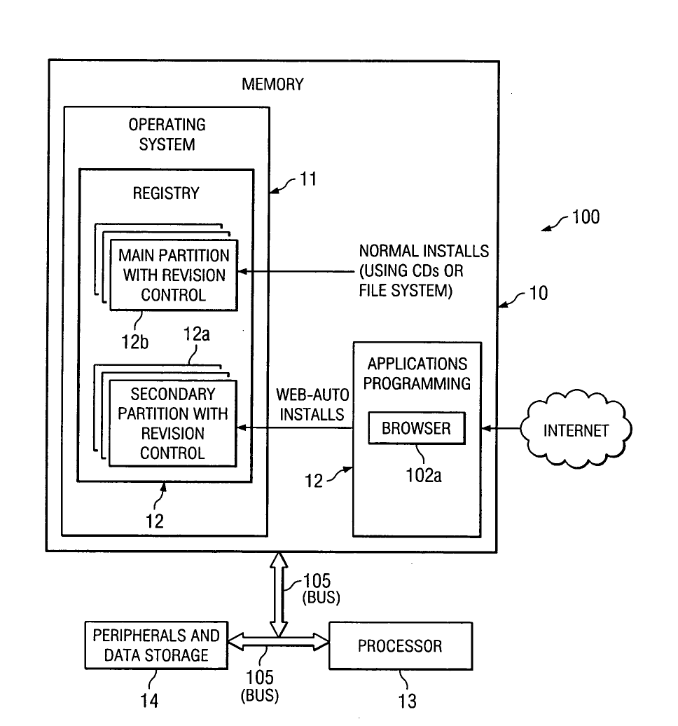

FIG. 1 illustrates an information handling system 100 having a registry 12 structured and operated in accordance with the invention. Certain modifications, such as partitioning and availability of prior versions of registry 12, are illustrated in FIG. 1. These and other registry features described herein may be implemented with appropriate programming to the programming that manages the registry, referred to herein as the operating system.

For purposes of this disclosure, an information handling system may include any instrumentality or aggregate of instrumentalities operable to compute, classify, process, transmit, receive, retrieve, originate, switch, store, display, manifest, detect, record, reproduce, handle, or utilize any form of information, intelligence, or data for business, scientific, control, or other purposes. For example, an information handling system may be a personal computer, a network storage device, or any other suitable device and may vary in size, shape, performance, functionality, and price. The information handling system may include random access memory (RAM), one or more processing resources such as a central processing unit (CPU) or hardware or software control logic, ROM, and/or other types of nonvolatile memory. Additional components of the information handling system may include one or more disk drives, one or more network ports for communicating with external devices as well as various input and output (I/O) devices, such as a keyboard, a mouse, and a video display. The information handling system may also include one or more buses operable to transmit communications between the various hardware components.

In FIG. 1, only the most basic elements of information handling system 100 are explicitly illustrated. It has an memory 10, in which an operating system 11 and applications programming 12 are stored. A memory 10 communicates with processor 13 via a bus 15, as do various peripheral devices 14. For purposes of this description, peripheral devices 14 include mass storage for data and applications code, such as a hard disk drive.

The information handling system 100 of FIG. 1 is assumed to be “web enabled”, that is, its applications programming 102 includes a web browser 102a.

In general, for purposes of this description, operating system 11 is any software having at least the basic functions of managing hardware and software resources of the system, and providing a consistent way for applications programming 12 to deal with the hardware of system 100 without having to know all the details of the hardware.

For purposes of example herein, operating system 11 is a Windows operating system, of the family of operating system available from Microsoft Corporation. Other types of operating systems are the Macintosh operating systems developed by Apple, and the UNIX family of operating systems developed by various collaborators.

It is assumed that operating system 11 has a partitionable registry. Registry 12 contains information and settings for all the hardware, software, users, and preferences of the system 100. It is where computer system 100 stores information about the system configuration and stored programs.

In today's versions of Windows, the registry 12 is a “flat” database used to store various settings and options. Whenever a user makes changes to a Control Panel settings, or File Associations, System Policies, or installed software, the changes are reflected and stored in the Registry. The registry entries are referred to as “keys”, and each key relates to a program or setting on system 100. At run time for an executable software program, Windows reads the keys and uses the information to launch and run that software.

Other operating systems are designed similarly to Windows in the sense that they use a metadata repository in a manner similar to a Windows registry. Although the invention described herein is in terms of registry entries of a Windows-based computer system, the same concepts apply to any set of software metadata used to launch and run other programming. The terms “registry” and “registry entries” are used herein to equivalently refer to any such metadata repository and its metadata entries.

Registry entries are instrumental in uninstalling as well as installing software. If a program is to be completely uninstalled, in addition to removing its code from storage memory 14, its associated registry entries must also be removed from registry 12.

One feature of registry 12 is built-in revision control. This feature permits a prior version of registry 12 to be retrieved and re-instated as the “working” version, if a subsequent version is corrupted. The version control is multi-level in the sense that a series of prior versions are identified, saved, and retrievable.

A second feature of registry 12 is that it has the ACID properties of a database. ACID is the acronym used to describe four properties of many of today's databases: For ATOMICITY, a transaction should be done or undone completely. In the event of a failure, all operations and procedures should be undone, and all data should rollback to its previous state. For CONSISTENCY, a transaction should transform a system from one consistent state to another consistent state. For ISOLATION, each transaction should happen independently of other transactions occurring at the same time. As applied to registry 12, no two applications programs can override each other's values. For DURABILITY, completed transactions should remain permanent, even during system failure.

The third feature of registry 12 is that it is partitionable. As for other memory, for registry 12, partitions are used to divide an area of storage into separate isolated segments. A separate partition 12b of registry 12 stores registry information (i.e., registry keys) associated with software downloaded and installed via the Internet. The partitioning may be physical or logical, using techniques known in the art of data storage devices.

In FIG. 1, partition 12b is identified as the “secondary” partition. It enables a user to easily identify software that is downloaded from the Internet. A main partition 12b stores all registry information for all other software, such as software installed locally.

In one embodiment of the invention, operating system 11 is programmed to ensure that all “automatically installed” software is installed to secondary registry 12a. By “automatically installed” is meant software that is installed without active participation by the user, such as by clicking on a button in a dialog box. For example, today's Windows operation systems have an Active X feature that permits software download and installation to occur via the Internet under control of the Web-browser 102a. In accordance with the invention, such software would be installed to secondary registry 12a.

Cleaning software tools, such as today's “spyware cleaners” can be designed and installed in computer system 100. By accessing secondary partition 12a, these tools can easily identify and remove Web-installed registry entries. The removal can be automatic, or the user may view a list of registry entries and remove only what is desired to be removed. Even “locked” keys can be listed and removed. Similarly, when software is installed via the Internet, computer system 100 can be programmed to query the user whether the new software should be installed to the main registry or the secondary registry.

Although the disclosed embodiments have been described in detail, it should be understood that various changes, substitutions and alterations can be made to the embodiments without departing from their spirit and scope.

What is claimed is:

1. A method of protecting a web-enabled information handling system against malware, the information handling system having a registry, comprising:
operating the registry as a database having ACID (atomicity, consistency, isolation, and durability) properties; and
partitioning the registry into at least two partitions, wherein the partitions include at least a secondary partition operable to store entries associated with software installed via the Internet and a main partition for storing entries associated with software installed locally.

2. The method of claim 1, further comprising the steps of storing at least one prior version of the registry, and operating the registry such that a prior version may be reinstated.

3. The method of claim 1, wherein the registry is associated with a Windows operating system.

4. The method of claim 1, wherein the entries stored in the secondary registry are associated with automatically installed software.

5. The method of claim 1, wherein the secondary registry is operable to provide a list of all registry entries and to remove any entry upon selection of that entry from the list by a user.

6. The method of claim 1, wherein the secondary registry is operable such that an entry cannot override another entry.

7. A computer-readable media for managing a registry of a web-enabled information handling system such that the information handling system is protected from malware, the media having programming comprising:
programming for operating the registry as a database having ACID (atomicity, consistency, isolation, and durability) properties; and
programming partitioning the registry into at least two partitions, wherein the partitions include at least a secondary partition for storing entries associated with software installed via the Internet and a main partition for storing entries associated with software installed locally.

8. The media of claim 7, further comprising programming for storing at least one prior version of the registry, and operating the registry such that a prior version may be reinstated.

9. The media of claim 7, wherein the registry is associated with a Windows operating system.

10. The media of claim 7, wherein the entries stored in the secondary registry are associated with automatically installed software.

11. The media of claim 7, wherein the secondary registry is operable to provide a list of all registry entries and to remove any entry upon selection of that entry from the list by a user.

12. The media of claim 7, wherein the secondary registry is operable such that an entry cannot override another entry.

13. An improved operating system for a web-enabled information handling system, the improvement comprising:
registry management programming that operates the registry as a database having ACID (atomicity, consistency, isolation, and durability) properties; and partitions the registry into at least two partitions, wherein the partitions include at least a secondary partition that stores entries associated with software installed via the Internet and a main partition that stores entries associated with software installed locally.

14. A web-enabled information handling system, comprising:
a processing system; and
memory for storing an operating system, the operating system having registry management programming for protecting the system against malware by operating the registry as a database having ACID (atomicity, consistency, isolation, and durability) properties; and partitioning the registry into at least two partitions, wherein the partitions include at least a secondary partition that stores entries associated with software installed via the Internet and a main partition that stores entries associated with software installed locally; and
a bus for providing data communications between the processing system and the memory.

15. The system of claim 14, wherein the registry management programming is further operable to store at least one prior version of the registry and to operate the registry such that a prior version may be reinstated.

16. The system of claim 14, wherein the registry is associated with a Windows operating system.

17. The system of claim 14, wherein the entries stored in the secondary registry are associated with automatically installed software.

18. The system of claim 14, wherein the secondary registry is operable to provide a list of all registry entries, and to remove any entry upon selection of that entry from the list by a user.

19. The system of claim 14, wherein the secondary registry is operable such that an entry cannot override another entry.
